(19) United States
(12) Patent Application Publication
(10) Pub. No.: US 2016/0258190 A1
(43) Pub. Date: Sep. 8, 2016

(54) SECURING DEVICE

(71) Applicant: BELOXX GMBH & CO. KG, Wuppertal (DE)

(72) Inventor: Peter BOCK, Schwelm (DE)

(73) Assignee: Beloxx GmbH & Co. KG, Wuppertal (DE)

(21) Appl. No.: 15/032,853

(22) PCT Filed: Oct. 29, 2014
(86) PCT No.: PCT/EP2014/073202

§ 371 Date: Apr. 28, 2016

(30) Foreign Application Priority Data
Oct. 29, 2013 (DE) 10 2013 017 893.2

(51) Int. Cl. E05B 55/12; E05B 1/00; E05B 65/00

(52) U.S. Cl. CPC E05B 55/12; E05B 65/0075; E05B 1/0007

(57) ABSTRACT

The invention relates to a device (10) for securing a closed position of a closing element (12) arranged movably on a frame, the device comprising at least a bolt (14), which is arranged movably in the direction of action thereof along a bolt axis, and at least one groove (16), and having an actuating means (32) and a closing body (42). The invention proposes that the device (10) comprises an elongate securing element (26) which is arranged on the bolt (14), is movable along the bolt axis relative to the bolt (14) and has a cam (28), wherein the cam (28) at least partially engages in the groove (16). Furthermore, the device (10) according to the invention has a blocking device (48) which engages in the groove (16) in a locking position, as a result of which the freedom of movement of the bolt (14) is blocked.

The invention relates to a device for securing a dosed position of a dosing element arranged movably on a frame, in particular of a flap, door or the like. Furthermore, the present invention relates to a lockbox.

A plurality of securing devices according to the generic species is known from prior art technology. Locks are preferably used for securing the closed position of a closing element arranged movably on a frame. Locks are mounted preferably on doors, lockers, lockboxes, mailboxes or the like and they serve for permitting access into certain areas to selected persons and for refusing such access to other persons. A lock is always comprised of a closing mechanism whose form and mode of action is adapted to the system to be locked. Usually these are push bolt lock solutions in which the bolt engages into a corresponding locking plate, thus preventing a relative movement between frame and closing element.

Electronic locks are increasingly utilized for the locking of lockboxes. To shut these locks, both rotary and push bolts are used. Preferably the push bolts are equipped with a latchbolt. To simply have to push the cabinet doors shut for locking, spring-supported bolts with a lead-up slope are used. With prior art locks, however, the bolts themselves are not secured in a locking position, i.e. with a locked door in which the bolt engages into a corresponding dosing plate. Merely the handling is hampered in its movability in the locking position. The bolt itself remains movable even in the locking position. This may result in that locks of this kind can easily be opened even in the locking position. To this effect, the bolt can be pushed out from the closing plate by simple manipulation from the lockbox outside. This can be realized, for example, by introducing a chipcard between the frame and closing element.

Locks known from prior art have a disadvantage in that it cannot be assured that an unauthorized opening of the closing element in a locking position can really be prevented. Instead, it is easily possible for unauthorized persons to open such systems without major effort and to get access to locked goods.

Now, therefore, it is the object of the present invention to provide a device and/or a lockbox in which not only the handling is blocked in its freedom of movement, but in which the bolt itself is also secured against shifting and/or twisting and in which an opening of the device by manipulation can largely be prevented.

This object is achieved by a device comprising the characteristic features of claim 1 as well as by a lockbox comprising the characteristic features of claim 13. Advantageous embodiments each are the subject of dependent claims. It should be noted that the characteristic features listed individually in the patent claims can also be combined with each other in any arbitrary and technologically reasonable manner, thus demonstrating further embodiments of the present invention.

An inventive device for securing a closed position of a closing element arranged movably on a frame at least is comprised of a bolt which is arranged movably in the direction of action thereof along a bolt axis, and having at least one groove, an actuating means, and a closing body. Furthermore, the inventive device comprises an elongate securing element which is arranged on the bolt, is movable along the bolt axis relative to the bolt, and has a cam, wherein the cam in an unlocking position at least partially engages in the groove, and a blocking element which in a looking position engages in the groove, as a result of which the freedom of movement of the bolt is blocked.

As compared with prior art in technology, the inventive device has the advantage that the bolt itself, too, can be restricted in its freedom of movement and that a shifting and/or twisting is thus no longer possible. In a locking position of the inventive device, it is no longer possible to lever the bolt easily out from the closing body. Thus, access to dosed rooms is significantly complicated to non-authorized persons.

in terms of the present invention, a locking position is understood to be a position in which the bolt is arrested and cannot be moved along its direction of action, i.e. the bolt axis. When talking of a movement of the bolt in accordance with the present invention, it means both a shifting and a twisting of the bolt. In the inventive unlocking position, the bolt is freely movable in its direction of action. The bolt can be moved along its direction of action.

To be considered as closing elements in particular are wings, flaps, doors, or the like. The closing element can be supported in swivable or slidable mode in the frame. Usually, the bolt is arranged on the closing element. In principle, however, an installation in the frame is also feasible. Apart from using push-type bolts, it is furthermore also possible to use rotatorily movable turning bolts.

The bolt may comprise a bolt tip. Preferably, the bolt tip is tapered. Hence, the bolt comprises a lead-up slope. Arranged on the bolt may be a spring, preferably a compression spring. Ideally, the compression spring acts in the direction of the bolt tip. Thus, the bolt is permanently pressed into a closed position. According to the present invention, closed position means the position in which the bolt protrudes at least partially, preferably with its bolt tip, beyond the closing element and/or frame, depending on which part the bolt is arranged on. In closed position, the bolt can be brought into engagement with the closing body. Preferably, the bolt is arranged in a bolt guide.

The inventive oblong securing element which is preferably shaped like a rod Is movably arranged in the direction of action of the bolt relative to the bolt between a front and a rear position. When the securing element is situated in the front position, the cam lies at least partially in the groove of the bolt. Hereby, it is prevented that the blocking element can move into the groove. The bolt is then arranged movably along its direction of action. When the securing element is situated in the rear position, the cam lies outside the groove. Thus, the groove is released for the blocking element. The blocking element can move into the groove.

Advantageously, a spring is arranged on the securing element. Preferably it is a compression spring, for example a helical spring. By way of the compression spring, the securing element is ideally pressed permanently into the direction of the bolt tip. Thus, the securing element is situated in an inventively front position. This bears the advantage that the bolt in principle is situated in the unlocking position and is freely movable in the direction of its direction fo action.

The transition between unlocking position and locking position is described in the following:

When the closing element is shut, the bolt is preferably slid via its lead-up slope through a limit stop of the closing body into a box of the closing body. When the closing element is situated in an end position, the bolt is pressed by the compression springs into the box. Through the limit stop of the closing body, the bolt securing means, too, although it is pressed in general permanently by a compression spring into the direction of the bolt tip, is prevented from moving out again together with the bolt. The securing element is thus slid into the rear position. In this position, the cam of the securing element is no longer situated in the groove and thus releases it for the blocking element. The blocking element now moves into the groove. The inventive device is now situated in the locking position. The bolt is secured against sliding and/or twisting.

Now, when the entry of the correct opening code can be realized, for example via a keyboard, RFID, fingerprint, bluetooth or the like, the blocking element moves out from the groove and releases the bolt for a certain period of time. A user of the device can now lake the bolt from the closed position into an open position, for example by manually actuating the actuating means. After the boil has been moved out from the closing box, the closing element can subsequently be opened. When the closing element is again open, the securing element is brought by the compression spring into the front position and the cam moves into the groove, thus preventing that the blocking element can again move in.

The inventive device is now again situated in the unlocking position. Then the bolt is again freely movable along its direction of action.

Ideally, the securing element is slidably embedded in the bolt. To this effect, the bolt comprises elongate recesses at least in the direction of action of the bolt. Such a configuration has the advantage in that the inventive device can be of the most compact possible type of construction and thus, despite additional elements, can easily be connected with conventional locks.

A spring may be arranged on the inventive blocking element. Ideally, it is a compression spring which presses the blocking element permanently into the direction of the groove. When the groove is released by the securing element, the blocking element driven by the compression spring automatically moves into the groove. A shifting of the bolt along its direction of action is no longer possible now. The inventive device is situated in the locking position.

Preferably, the blocking element is a push-type blocking element. However, it is also possible to configure the blocking element as a swivel-type blocking element.

The inventive bolt and the actuating means can be connected with each other mechanically. Thus the bolt is moved and/or driven by the actuating means. Preferably utilized as actuating means is a rotary knob. However, it is also possible to configure the actuating means as a sliding element.

Ideally, the bolt is not connected directly to the actuating means, but there is a coupling element arranged between the bolt and the actuating means. Advantageously, the coupling element transforms a rotatory movement of the actuating means, for example a rotary knob, into a translatory movement of the bolt. The coupling element may comprise a disk-shaped element on which a pin is eccentrically arranged. As a counterpart to the pin, the bolt may comprise a recess which extends in parallel to the direction of action of the bolt. The pin engages into the recess extending in the direction of action of the bolt. When actuating the actuating means, the pin pushes against the walls of the recess and thereby it moves the bolt into the appropriate direction. However, this is only possible if the device is situated in the unlocking position. Thus, the bolt can be moved between the open and the closed position.

The bolt is preferably made of a metallic material. Advantageously, the bolt is at least partially sheathed with a plastic. Particularly preferably, only some areas of the bolt tip are sheathed with a plastic element. By using a plastic element, it Is not the bolt with Its mostly metallic surface but the plastic element that touches the frame when closing and/or opening the closing element. Despite a frequent opening and closing of the closing element, wear and tear on the frame and/or bolt can thus be prevented. When the plastic element has worn off after frequent opening or closing, it can easily be exchanged at low-cost for a new element. Advantageously, the plastic element is a clip that is simply clipped onto the bolt tip. But it is also conceivable to glue the plastic element onto the bolt. Particularly suitable for use as plastic material are thermoplasts, for example polyamides.

The invention as well as the technical environment are explained in greater detail in the following by way of illustrative figures, and it should be noted that these figures show a particularly preferred embodiment variant of the present invention. However, the present invention is not restricted to the embodiment variant shown here. In particular, inasmuch as technically reasonable, the invention comprises arbitrary combinations of the technical features itemized in the sub-claims or described as being relevant for the invention in the description.

Where:

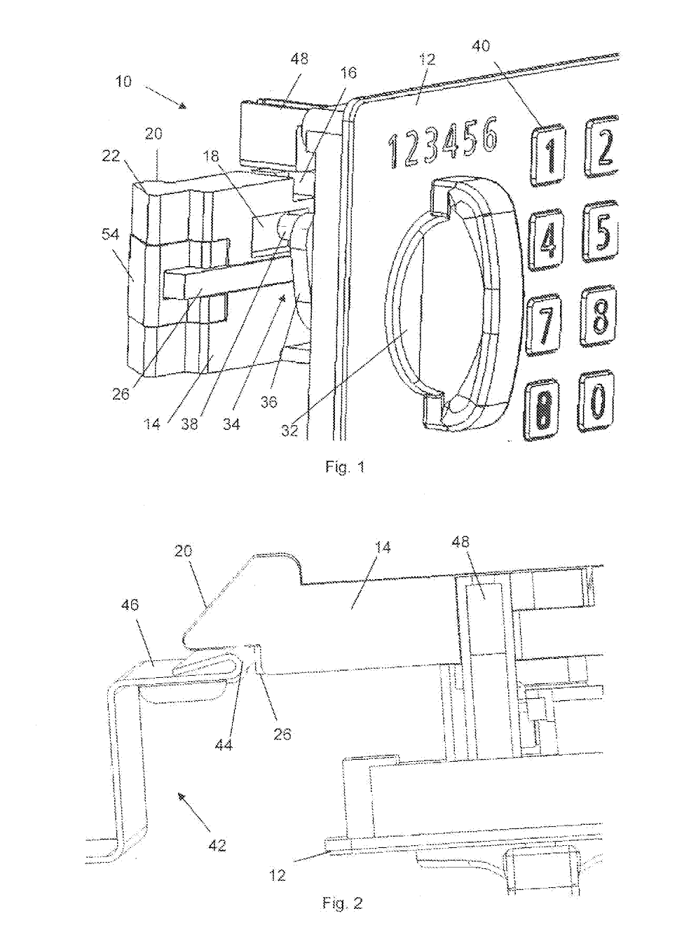

FIG. 1 is a schematic representation of an inventive device in an unlocking position in one embodiment,

FIG. 2: is a schematic representation of an inventive device in a locking position,

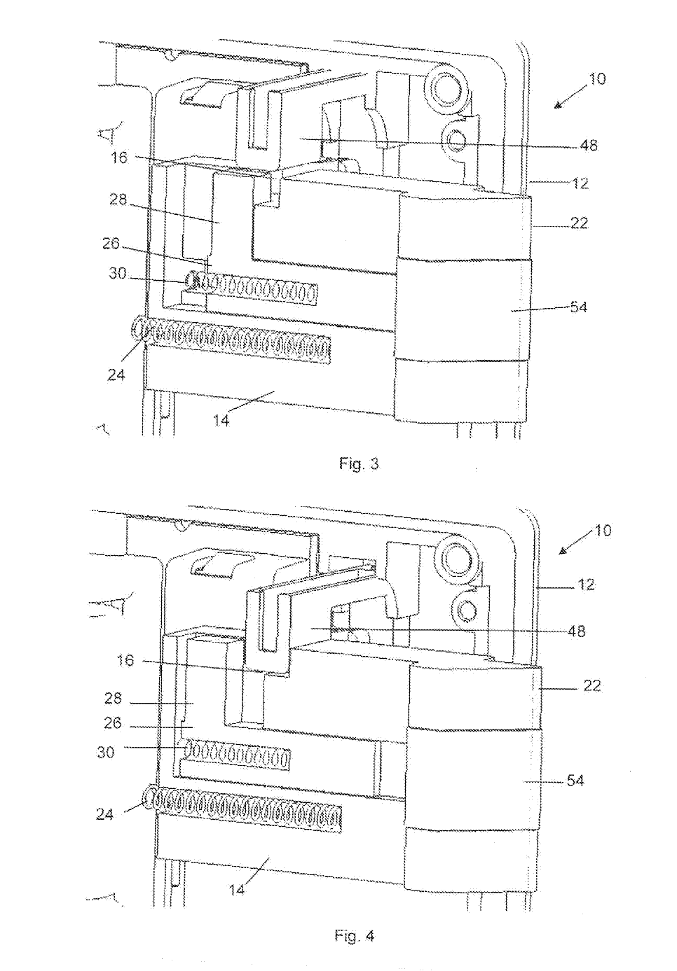

FIG. 3: is a further schematic representation of an inventive device in an unlocking position,

FIG. 4: is a further schematic representation of an inventive device in a locking position,

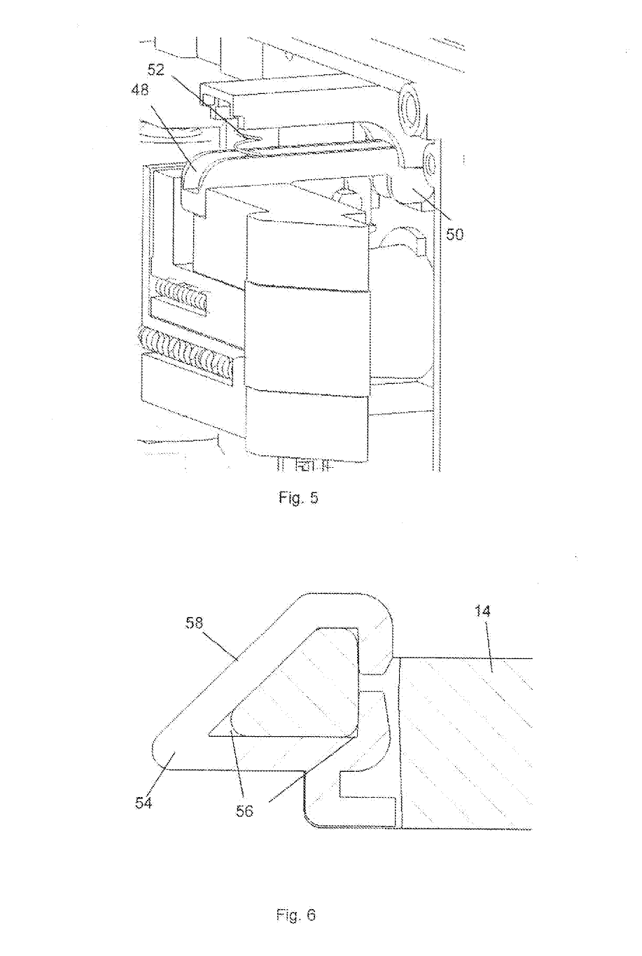

FIG. 5: is a schematic representation of an inventive device in a locking position in a further embodiment,

FIG. 6: is a sectional view of a bolt tip.

FIG. 1 shows a schematic representation of an inventive device 10 in an unlocking position. Device 10 comprises a closing element 12. Preferably, the closing element 10 is a door. Furthermore, the inventive device 10 comprises a bolt 14. Bolt 14 is movably arranged in the direction of arrow, i.e. the direction of action of the bolt. At its upper side, bolt 14 has a groove 16. Moreover, it comprises a lead-up slope 20. When the closing element 12 is shut, the bolt 14 can be siid-in without major power demand via its lead-up slope 20 through a door profile into a box 46.

Furthermore, device 10 comprises an elongate securing element 26 which is arranged on bolt 14. The securing element 26 is movably arranged between a front and a rear position relative to bolt 14 in the direction of action of bolt 14. Preferably, the securing element 26 is permanently pressed by a compression spring 30 in the direction of a bolt tip 22. The securing element 26 comprises a cam 28. When the securing element 28 is situated in the front position, cam 28 lies in the groove 18 of bolt 14. When the securing element 28 is situated in the rear position, cam 28 lies outside from groove 16.

In FIG. 1, bolt 14 is connected via coupling element 34 to a rotary knob 32. The coupling element 34 transforms the rotatory movement of rotary knob 32 into a translatory movement of bolt 14. The coupling element 34 comprises a disk-shaped element 36 on which a pin 38 is eccentrically arranged. Pin 38 engages into a recess extending in the direction of action of bolt 14. When rotary knob 32 is turned, pin 38 pushes against a wall of recess 18 of bolt 14 and slides the bolt 14 along its direction of action. However, this is only feasible if there is an unlocking position.

Rotary knob 32 is arranged on the front side of closing element 12. Furthermore, a keyboard 40 is arranged on the front side. The opening code is entered via this keyboard 40. However, it is also conceivable to enter the code via RFID, fingerprint bluetooth, or the like instead of entering it via a keyboard 40. A use of a key is not ruled out either, if a user wants to open the closing element 12, transfer the inventive device 10 from a locking position into an unlocking position, he and/or she must enter the correct opening code via keyboard 40. Once done, a blocking element 48 extends from the groove 16 and releases the bolt 14 again for a certain period of time. A user of device 10 can now transfer bolt 14 from the closed position into the open position by actuating rotary knob 32, and open the closing element 12.

FIG. 2 shows a schematic representation of an inventive device 10 in a locking position. In FIG. 2, the closing element 12 is shut and device 10 is situated in a locking position. Bolt 14 is pressed by a compression spring 24 acting permanently in the direction of bolt tip 22 into a box 46 of a closing body 42. By way of a limit stop 44 of closing body 42, the securing element 28 is prevented from moving out again together with bolt 14. Securing element 26 is slid into the rear position. In this position, cam 28 of securing element 26 is no longer situated in groove 16. The blocking element 48 which is permanently pressed by a spring 52 into the direction of groove 16 moves into groove 16. The inventive device 10 is now situated in the locking position. Bolt 14 is secured against shifting and/or twisting.

FIG. 3 shows a schematic representation of an inventive device 10 in an unlocking position. In this position, bolt 14 is freely slidable in a guide in its direction of action. Both on the securing element 26 and on bolt 14, one compression spring 24, 30 each is arranged. Springs 24, 30 act permanently in the direction of bolt tip 22. When the closing element 12 is open, bolt 14 is pressed into an inventive closed position, and the securing element 26 is pressed into an inventive front position. Cam 28 of securing element 26 thus at least partly lies in groove 16 of bolt 14, and prevents the blocking element 48 from entering into groove 18 of bolt 14.

FIG. 4 shows a schematic representation of an inventive device 10 in a locking position in one embodiment. In this position, bolt 14 is secured against sliding along the direction of action. Securing element 28 is situated in a rear position whereby cam 28 is located outside from groove 18. The blocking element 48 which is configured as a push blocking element engages into groove 16. Shifting of the bolt 14 along the direction of action is thus no more possible.

FIG. 5 shows a schematic representation of an inventive device 10 in a locking position in a further embodiment. In this representation, the blocking element is configured as a swivel-type blocking element. The blocking element 48 is pivotably arranged at a first end in a pivot point 50. In the area of the second end, a compression spring 52 is arranged on the blocking element 48. Spring 52 presses the blocking element 48 permanently into the direction of groove 16. As the securing element 26 releases the groove 16, the blocking element 48 driven by compression spring 52 automatically moves into groove 16. In FIG. 5, the securing element 26 is situated in the rear position. Cam 28 lies outside groove 18.

FIG. 8 shows a sectional view of a bolt tip 22. At least some areas of the bolt tip 22 are surrounded by a plastic element 54 comprising gliding surfaces 58. In the area of the plastic element 54, the bolt tip 22 comprises a deepening 58. The plastic element 54 which is preferably configured like a clip is simply clipsed into this deepening 56 onto the bolt tip 22. With the plastic element 54 being arranged in the deepening 56, a shifting of the plastic element 54 vertically to the sectional plane can be prevented. The advantage of utilizing a clip-like element 54 lies in that it can easily be exchanged for a new one if required, for example when it has worn out.

The gliding surfaces 58 of the plastic element 54 preferably protrude so far that the bolt 14 with its metallic base body need not glide past the dosing body 42, but can glide gently over the plastic element 54. Despite a frequent opening and closing of the closing element 12, it is thus possible to prevent wear and tear on the closing body 42 and/or bolt 14. Particularly suitable for use as plastic are thermoplastics, e.g. polyamides.

### LIST OF REFERENCES

10 Device

12 Closing element

14 Bolt

16 Groove

18 Recess

20 Lead-up slope

22 Bolt tip

24 Compression spring (bolt)

26 Securing element

28 Cam

30 Compression spring (securing element)

32 Rotary knob

34 Coupling element

36 Disk-shaped element

38 Pin

40 Keyboard

42 Closing body

44 Limit stop

46 Box

48 Locking (push) element

50 Pivot point

52 Compression spring

54 Plastic element

56 Deepening

58 Gliding surface

1: Device (10) for securing a closed position of a closing element (12) arranged movably on a frame, the device comprising at least a bolt (14), which is arranged movably in the direction of action thereof along a bolt axis, and at least one groove (16), and having an actuating means (32) and a closing body (42),
wherein
an elongate securing element (26) which is arranged on the bolt (14), is movable along the bolt axis relative to the bolt (14) and has a cam (28), wherein the cam (28) in an unlocking position at least partially engages in the groove (16), and
has a blocking device (48) which engages in the groove (16) in a locking position, as a result of which the freedom of movement of the bolt (14) is blocked.

2: Device (10) according to claim 1, wherein the bolt (14) comprises a lead-up slope (20) at one bolt tip (22).

3: Device (10) according to claim 1, wherein the securing element (26) is slidably embedded in the bolt (14).

4: Device (10) according to claim 1, wherein a spring (24), preferably a compression spring, is arranged on the bolt (14).

5: Device (10) according to claim 1, wherein a spring (30), preferably a compression spring pressing the securing element (26) into the direction of the bolt tip (22) is arranged on the securing element (26).

6: Device (10) according to claim 1, wherein the blocking element (48) is a push blocking element.

7: Device (10) according to claim 1, wherein the blocking element (48) is a swiveling blocking element.

8: Device (10) according to claim 1, wherein, a spring (52), preferably a helical spring, is arranged on the blocking element (48).

9: Device (10) according to claim 1, wherein the actuating element (32) is a rotary knob.

10: Device (10) according to claim 1, wherein the bolt (14) is mechanically connected via a coupling element (34) to the actuating means (32).

11: Device (10) according to claim 10, wherein the coupling element (34) is a disk-shaped body (32) on which a pin (38) is eccentrically arranged.

12: Device (10) according to claim 1, wherein the bolt (14) is at least area-wise coated with a plastic element (54), preferably in the area of the bolt tip (22).

13: Lockbox comprising a device (10) according to claim 1.
